(19) United States
(12) Patent Application Publication
(10) Pub. No.: US 2026/0137068 A1
(43) Pub. Date: May 21, 2026

(54) Sticky Trap Assembly

(71) Applicant: Marcella Donat, Hamilton (CA)

(72) Inventor: Marcella Donat, Hamilton (CA)

(21) Appl. No.: 18/955,004

(22) Filed: Nov. 21, 2024

(51) Int. Cl. A01M 1/14

(52) U.S. Cl. CPC A01M 1/14

(57) ABSTRACT

A sticky trap with a protective guard for capturing pests is disclosed. The trap includes a substrate member with a non-adhesive perimeter and a guard member that forms a channel to receive and protect the substrate. The substrate member is coated with adhesive on at least one or both sides for pest capture, while the non-adhesive perimeter allows for easy handling. The guard member includes a border that overlaps the non-adhesive perimeter, shielding the adhesive surface from unintended contact with skin, plant leaves, human hair, or pet fur. The guard is able to receive a mounting attachment, such as a stake for positioning the trap upright in soil, or a spring clip for securing the trap to plant pots, furniture, or other surfaces. The guard member includes a diagonal support to prevent unintended objects from contacting the adhesive, and a yellow substrate color to enhance pest attraction.

### BACKGROUND OF THE INVENTION

The present invention relates to pest control devices, particularly sticky traps used to capture small insects such as gnats, aphids, fruit flies, and other household pests. More specifically, this invention is designed to provide a safer, cleaner, and more versatile solution for trapping pests while preventing or reducing the risk of unintended contact with non-target objects like human hair, pet fur, and plant leaves.

Traditional sticky traps consist of adhesive panels coated on one or both sides to attract and capture pests. While effective, these traps often present several issues, particularly in indoor environments where they are commonly used near plants, in homes with pets, or around young children. The exposed adhesive surface can inadvertently come into contact with plant foliage, resulting in damage or mess. Pets, such as cats or dogs, may also come into contact with the sticky surface, leading to fur adhesion and distress. Moreover, children may be drawn to the brightly colored adhesive traps, posing a risk of skin contact or ingestion of pests stuck to the adhesive.

Another challenge with current sticky traps involves their method of deployment. Many traps utilize stakes that are inserted into soil near potted plants. Removing these stakes often results in soil displacement or spillage, creating additional cleaning burdens. Furthermore, the position of the traps in the soil can limit their effectiveness, as plant leaves and stems may interfere with the adhesive surface, reducing the trap's ability to capture pests.

There is a need for an improved sticky trap design that addresses these limitations. Specifically, there is a demand for a trap that prevents unwanted contact with non-target objects, avoids soil displacement, and allows for more versatile placement options. The present invention offers a solution by incorporating a guard member that shields the adhesive surface and enables the trap to be securely positioned in multiple ways, including via a stake for upright soil placement or a clip for attachment to pots, curtains, furniture, or a rim of a jar with vinegar.

In light of the devices disclosed in the known art, it is submitted that the present invention substantially diverges in design elements and methods from the known art and consequently it is clear that there is a need in the art for an improvement for a sticky trap that captures pests while minimizing interfering with pets and other items or people. In this regard the instant invention substantially fulfills these needs.

### SUMMARY OF THE INVENTION

In view of the foregoing disadvantages inherent in the known types of sticky traps currently available in the prior art, the present invention provides an improved sticky trap assembly with a protective guard that addresses issues related to unintended contact with non-target objects such as skin, plant leaves, human hair, or pet fur. The sticky trap assembly comprises a substrate member with a non-adhesive perimeter and a guard member that forms a channel to receive the substrate member. The guard member includes a border that overlaps the non-adhesive perimeter, shielding the adhesive surface from accidental contact while maintaining its effectiveness in trapping pests.

The guard member is configured to receive various mounting attachments, allowing the trap to be positioned upright in soil via a stake, or clipped to surfaces such as plant pots or furniture using a spring clip. The substrate member is coated with adhesive on at least one or both sides to capture pests, and the assembly further incorporates features such as diagonal support members to prevent plant leaves from sticking to the adhesive. The trap is designed for versatile placement, improved safety, and effective pest capture in indoor environments.

It is an objective of the present invention to provide a sticky trap assembly with a protective guard that reduces the risk of unintended contact with non-target objects such as human hair, pet fur, and plant leaves.

It is an objective of the present invention to provide a sticky trap that offers multiple mounting options, including a stake. The stake is used to position the trap upright in soil and a spring clip attaches directly to plant pots or other surfaces, thereby increasing its versatility in indoor environments.

It is an objective of the present invention to provide a substrate member with adhesive on one or both sides, maximizing pest capture while incorporating a non-adhesive perimeter for easier handling and insertion into the guard member.

It is an objective of the present invention to incorporate diagonal support members into the guard which prevents plant leaves from contacting the adhesive surface. This ensures efficient pest trapping without damaging plants.

It is an objective of the present invention to provide a yellow-colored substrate to enhance pest attraction that makes the trap more effective at luring gnats, aphids, fruit flies, and other pests.

It is an objective of the present invention to provide a sticky pest assembly that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the sticky trap assembly, showing the adhesive-coated substrate member inserted into the guard member.

FIG. 2 shows a front view of an embodiment of the adhesive substrate member, displaying the non-adhesive perimeter and the tab at the top for easy removal.

FIG. 3 shows an overhead perspective view of an embodiment of the guard member, showing the front and rear panels forming a channel that holds the substrate member in place while preventing contact with the adhesive surface.

FIG. 4 shows a perspective view of an embodiment of the sticky trap assembly with a spring clip attached to the guard member, demonstrating how the clip secures the trap to the rim of a plant pot or other surfaces.

FIG. 5 shows a perspective view of an embodiment of the sticky trap assembly in an upright position, secured by a stake inserted into the soil, highlighting the use of the stake as a mounting attachment.

### DETAILED DESCRIPTION OF THE INVENTION

Reference is made herein to the attached drawings. Like reference numerals are used throughout the drawings to depict like or similar elements of the sticky trap assembly. For the purpose of presenting a clear description of the present invention, the preferred embodiment will be discussed for indoor pest control, particularly for trapping small insects such as gnats, aphids, fruit flies, and whiteflies. The figures are intended for representative purposes only and should not be considered limiting in any respect.

As used herein, the term “substrate member” refers to the structural layer of the sticky trap to which an adhesive is applied. The substrate member may be made from various materials, including but not limited to plastic films, paperboard, or cardstock. These materials are selected for their durability, flexibility, and ease of handling. The substrate member includes a non-adhesive perimeter, allowing it to be easily inserted and removed from the guard member without the risk of contact with the adhesive. The substrate member may be rectangular, with typical dimensions ranging between 5 cm to 12 cm in length and 3 cm to 6 cm in width, although other sizes may be used depending on the application. The thickness of the substrate is typically between 0.1 mm to 2 mm, depending on the material used, providing sufficient rigidity to hold its shape while also being lightweight for ease of use.

As used herein, the term “adhesive” refers to the tacky substance applied to the surface of the substrate member. The adhesive may be applied to one or both sides of the substrate member, depending on the desired application. The adhesive is designed to be non-permanent, meaning that it allows pests to stick to the surface upon contact, but the substrate can still be easily handled by users without a permanent bond forming. The adhesive may be based on synthetic or natural rubber compounds, pressure-sensitive adhesives (PSAs), or acrylic-based adhesives, all of which are commonly used in pest control products for their effectiveness in trapping small insects.

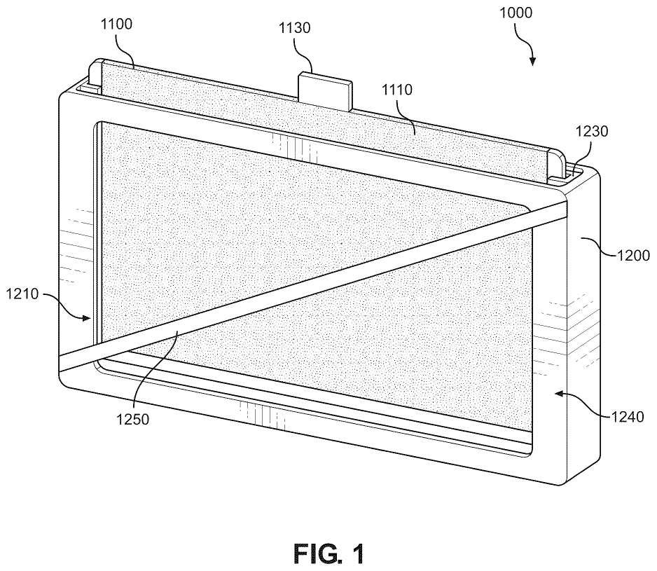

Referring now to FIGS. 1-3, there is shown a perspective view of one embodiment of the sticky trap assembly, including the substrate member and guard member, a front view of the substrate member, and an overhead perspective view of the guard member and substrate member, respectively. The sticky trap assembly 1000 is configured to trap pests and prevent unintended contact with plant leaves, human hair, or pet fur. In the shown embodiment, the sticky trap assembly 1000 comprises a substrate member 1100 having a non-adhesive perimeter 1120. A guard member 1200 forms a channel 1230 to receive the substrate member 1100, with a border 1240 that overlaps the non-adhesive perimeter 1120. The guard member 1200 is configured to receive a mounting attachment to secure the assembly in an upright position.

Referring specifically to FIG. 1, the substrate member 1100 inserted into the guard member 1200. The substrate member 1100 includes an adhesive portion 1110, which may be coated with adhesive on one or both sides for capturing pests. Surrounding the adhesive portion 1110 is the non-adhesive perimeter 1120, designed to facilitate easy handling and prevent accidental contact with the adhesive during insertion and removal from the guard member. The tab 1130, positioned at the top of the substrate member 1100, allows for easy removal of the substrate from the guard member 1200 after use.

In the shown embodiment, the guard member 1200 comprises a front panel 1210 and a rear panel 1220, forming the channel 1230 between them, sized to accommodate the substrate member 1100. The border 1240 of the guard member overlaps the non-adhesive perimeter 1120 of the substrate member, ensuring that the adhesive portion 1110 is exposed only in the central region while being protected from unintended contact with surrounding objects such as plant leaves, human hair, or pet fur. The panels of the guard member may be slightly curved or flat to protect the adhesive surface while providing easy visibility for pest attraction.

In one embodiment, the substrate member is coated with an adhesive on at least one side, configured to non-fixedly adhere pests thereto. Non-fixedly meaning a form of adherence or attachment that allows for temporary or reversible bonding. In this case, it means that pests can adhere to the adhesive-coated substrate upon contact, but the adhesion does not form a permanent or immovable bond, allowing for potential release or repositioning if necessary.

In the shown embodiment, the guard member 1200 further includes diagonal support members 1250 positioned between the front panel 1210 and rear panel 1220. These diagonal support members 1250 are designed to prevent nearby plant leaves, stems, or other objects from accidentally contacting the adhesive portion 1110 of the substrate member 1100. The diagonal supports extend from the inner surfaces of the guard member 1200 and are spaced to ensure that the adhesive portion remains fully exposed to pests while being shielded from potential obstructions. This configuration helps to maintain the effectiveness of the sticky trap by minimizing unintended interference with the adhesive surface.

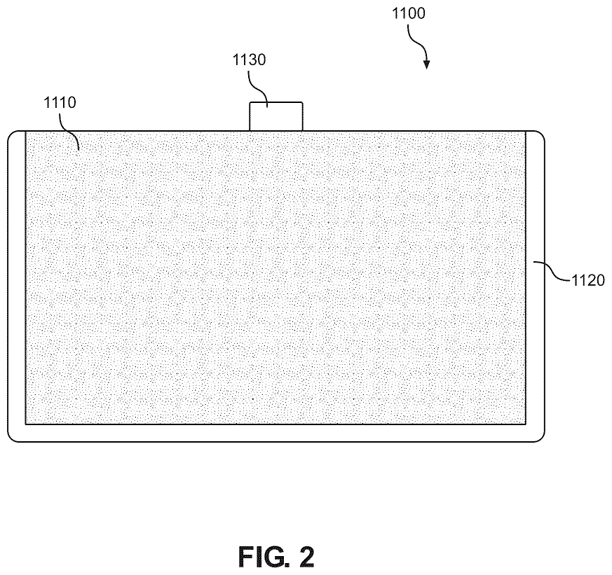

Referring specifically to FIG. 2, the adhesive portion 1110 occupies the central area of the substrate. The non-adhesive perimeter 1120 surrounds the adhesive portion, preventing unintentional contact with the adhesive while handling or inserting the substrate into the guard member 1200. The tab 1130 is positioned at the top of the substrate member 1100, making it easier for the user to pull out the substrate for disposal or replacement.

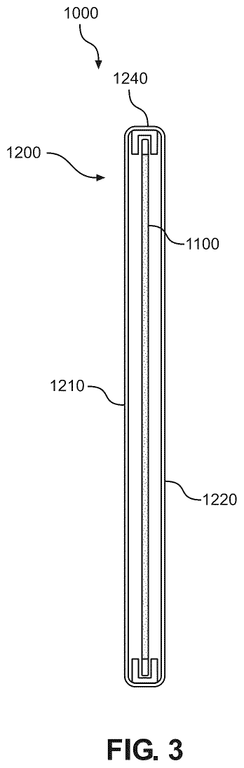

Referring specifically to FIG. 3, the channel 1230 formed by the front panel 1210 and rear panel 1220, is configured to hold the substrate member 1100 securely, while preventing the adhesive portion 1110 from contacting the inner surfaces of the guard. The border 1240 ensures that only the adhesive portion 1110 is exposed to pests while protecting the non-adhesive perimeter 1120. In one embodiment, the guard member 1200 is made from lightweight, durable plastic, offering sufficient rigidity to shield the adhesive portion and facilitate easy handling of the entire assembly.

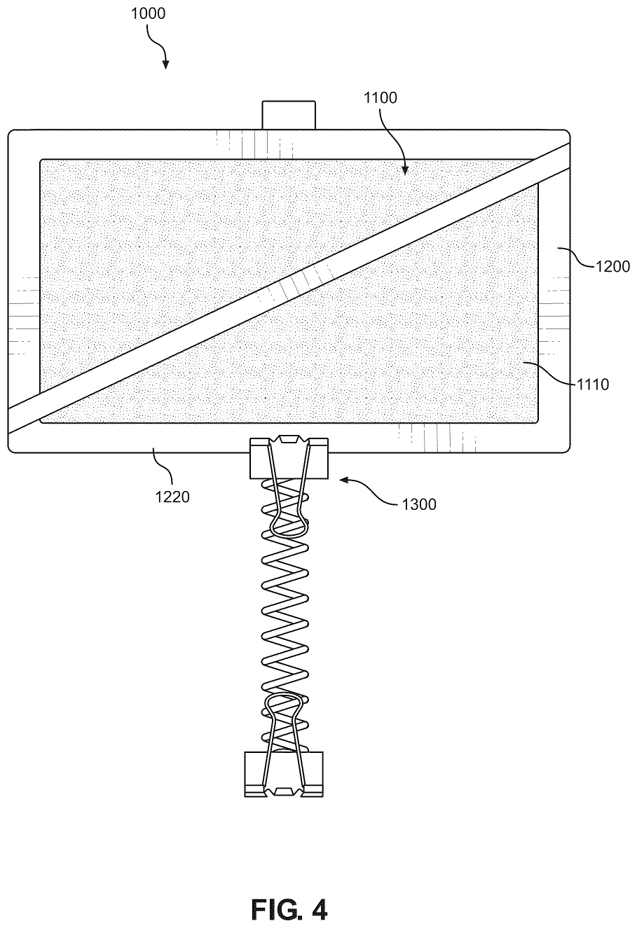

Referring now to FIG. 4, there is shown an embodiment of the sticky trap assembly 1000 with a spring clip 1300 attached to the guard member 1200. The spring clip 1300 is configured to secure the sticky trap assembly 1000 to various surfaces, such as the rim of a plant pot, furniture, or curtains, allowing for flexible placement.

In the shown embodiment, the spring clip 1300 is attached to the rear panel 1220 of the guard member 1200. The spring clip 1300 is designed to clamp onto objects with thicknesses up to approximately 1.3 cm, providing a stable connection that prevents the trap from shifting or falling once attached. The spring clip 1300 may be constructed from a durable metal or plastic material, ensuring sufficient clamping force while maintaining ease of use. The spring clip 1300 allows the sticky trap assembly 1000 to be positioned away from the soil, avoiding potential spillage or interference from plant stems, and providing an alternative mounting method to the stake 1400 shown in other embodiments. The flexibility provided by the spring clip 1300 makes the sticky trap suitable for various indoor environments, where it can be attached to a wide range of surfaces without needing to be placed directly in soil.

In one embodiment, the spring clip 1300 is removably attached to the guard member 1200, allowing the user to interchange it with other mounting attachments, such as the stake 1400. This configuration increases the versatility of the sticky trap assembly 1000, enabling it to be used in a variety of locations, depending on the user's needs. The spring clip 1300 is positioned such that it does not interfere with the adhesive portion 1110 of the substrate member 1100. The guard member 1200 continues to protect the adhesive surface from accidental contact, while the spring clip 1300 ensures that the sticky trap remains securely in place, maximizing pest capture effectiveness.

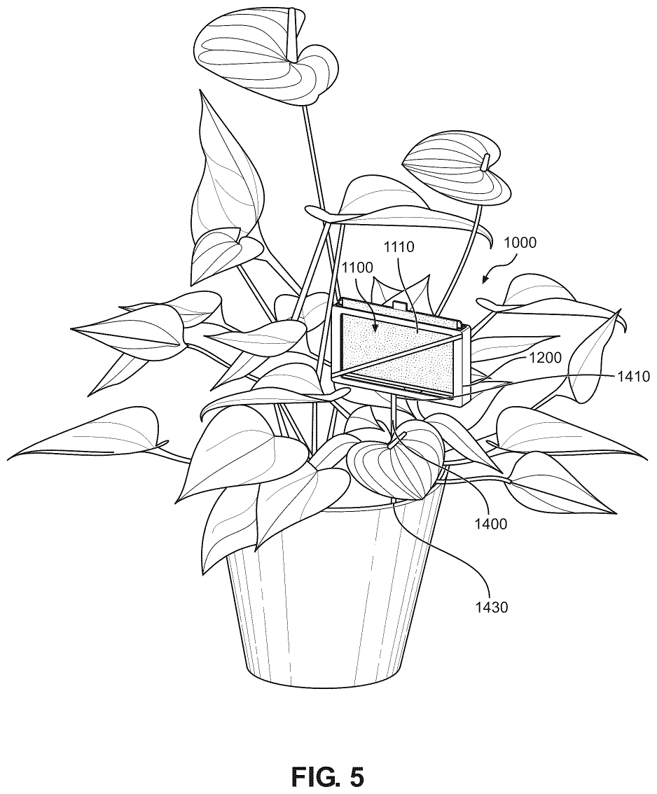

Referring now to FIG. 5, there is shown an embodiment of the sticky trap assembly 1000 with a stake 1400 attached to the guard member 1200. The stake 1400 is designed to mount the sticky trap assembly 1000 in an upright position by inserting the stake into soil, typically in a plant pot or garden bed. In the shown embodiment, the stake 1400 is connected to the bottom of the guard member 1200, specifically near the lower portion of the rear panel 1220. The stake 1400 is configured with a first end 1410 that engages with the stake receiving element 1420 located on the guard member, and a second end 1430 that is pointed or tapered to facilitate insertion into soil. The stake 1400 may be made from a durable material such as plastic or metal, providing sufficient rigidity to hold the sticky trap assembly 1000 upright.

The stake 1400 allows the sticky trap assembly 1000 to be positioned in close proximity to plants, where pests such as gnats, aphids, and fruit flies are commonly found. The upright orientation ensures that the substrate member 1100, including the adhesive portion 1110, is fully exposed, maximizing its ability to attract and trap pests. The non-adhesive perimeter 1120 ensures easy handling when inserting or removing the sticky trap from the soil.

In one embodiment, the stake 1400 is removably attached to the guard member 1200, allowing for interchangeable use with other mounting attachments, such as the spring clip 1300. This configuration provides the user with flexibility in deploying the sticky trap assembly 1000 in various environments, depending on whether soil-based or surface-based mounting is preferred.

The length of the stake 1400 is between 6-24 centimeters to ensure the stability of the sticky trap assembly 1000 once inserted into the soil. The second end 1430 is tapered to easily penetrate the soil without causing excessive disturbance to the plant's roots or surrounding areas. In one embodiment, the stake may also feature ridges or contours to further secure the sticky trap assembly in place.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A sticky trap with guard, comprising:
a substrate member, wherein the substrate member comprises a non-adhesive perimeter;
a guard member comprising a front panel and a rear panel forming a channel therebetween, sized to receive the substrate member therein;
wherein the guard member includes a border that overlaps the non-adhesive perimeter of the substrate member when received therein;
wherein the guard member is configured to receive a mounting attachment to secure the guard member in an upright position.

2. The sticky trap with guard of claim 1, wherein the substrate member is coated with an adhesive on at least one side, configured to non-fixedly adhere pests thereto.

3. The sticky trap with guard of claim 2, wherein the substrate member has adhesive on both sides, allowing pests to adhere to either side.

4. The sticky trap with guard of claim 1, further comprising a stake as the mounting attachment, wherein the stake includes a first end configured to engage with the guard member and a second end configured to penetrate soil, positioning the guard member and the substrate member in an upright orientation.

5. The sticky trap with guard of claim 4, wherein the substrate member is coated with an adhesive on at least one side, and wherein the stake is configured to maintain the substrate member in an upright position for enhanced pest capture.

6. The sticky trap with guard of claim 5, wherein the substrate member has adhesive on both sides, allowing pests to adhere to either side of the substrate member while in an upright orientation.

7. The sticky trap with guard of claim 4, wherein the stake is removable, and the guard member is configured to interchangeably receive either the stake or another mounting attachment.

8. The sticky trap with guard of claim 4, wherein the stake is made from a rigid material, and the second end is designed to penetrate soil to a depth sufficient to maintain the stability of the sticky trap assembly.

9. The sticky trap with guard of claim 1, further comprising a spring clip as the mounting attachment, wherein the spring clip is configured to secure the guard member to a surface, such as the rim of a plant pot, furniture, curtains, or a rim of jar containing vinegar.

10. The sticky trap with guard of claim 9, wherein the substrate member is coated with an adhesive on at least one side, and wherein the spring clip is configured to maintain the substrate member in an optimal position for pest capture.

11. The sticky trap with guard of claim 9, wherein the spring clip allows for attachment to objects up to approximately 1.3 cm in thickness.

12. The sticky trap with guard of claim 1, wherein the guard member further comprises diagonal support members on the front and rear panels, designed to prevent contact between plant leaves and the substrate member.

13. The sticky trap with guard of claim 1, wherein the guard member is made from plastic and is sized to completely enclose the perimeter of the substrate member without contacting the adhesive surface.

14. The sticky trap with guard of claim 1, wherein the substrate member is yellow in color to enhance pest attraction and has a tab at the top for easy removal from the guard member.
